(19) United States
(12) Patent Application Publication
(10) Pub. No.: US 2024/0425998 A1
(43) Pub. Date: Dec. 26, 2024

(54) AEM ROLL-TO-ROLL INK FORMULATIONS AND PROCESSES FOR CO2 ELECTROLYZERS

(71) Applicant: Twelve Benefit Corporation, Berkeley, CA (US)

(72) Inventors: Lihui Wang, Alameda, CA (US); Daniel J. Miller, Berkeley, CA (US); Joan Polena, Emeryville, CA (US); Kenta Ohtaki, Berkeley, CA (US); Thomas Yue Wu, Berkeley, CA (US)

(21) Appl. No.: 18/741,782

(22) Filed: Jun. 13, 2024

Related U.S. Application Data
(60) Provisional application No. 63/507,953, filed on Jun. 13, 2023.

(51) Int. Cl. C25B 9/23; C09D 11/108; C25B 3/26

(52) U.S. Cl. CPC C25B 9/23; C09D 11/108; C25B 3/26

(57) ABSTRACT

Provided herein are systems and methods for roll-to-roll deposition of membrane electrode assemblies (MEAs) and layers thereof. Embodiments of the systems and methods may be used for producing layers, including polymer electrolyte membranes (PEMs) and catalyst layers, of an MEA. In particular embodiments, the methods and systems may be used for producing anion-exchange membranes (AEMS). In other instances, the methods and systems may be used for producing cation-exchange membranes or bipolar membranes. Also provided are MEAs and layers thereof produced by the methods described herein. In some embodiments, the MEAs are configured for electrolysis and, in particular, for carbon oxide (COₓ) reduction. The methods and systems may also be employed for water electrolysis.

### STATEMENT OF GOVERNMENT SUPPORT

The Government has rights in this invention pursuant to contract DE-SC0019703 with the United States Department of Energy.

### INCORPORATION BY REFERENCE

An Application Data Sheet is filed concurrently with this specification as part of the present application. Each application that the present application claims benefit of or priority to as identified in the concurrently filed Application Data Sheet is incorporated by reference herein in their entireties and for all purposes.

### BACKGROUND

Membrane electrode assemblies (MEAs) for electrolytic carbon oxide reduction reactors can include polymer layers such as anion-exchange membranes (AEMs). Manufacturing processes for large-scale carbon oxide reduction reactors can affect the performance of the reactors.

Background and contextual descriptions contained herein are provided solely for the purpose of generally presenting the context of the disclosure. Much of this disclosure presents work of the inventors, and simply because such work is described in the background section or presented as context elsewhere herein does not mean that such work is admitted prior art.

### SUMMARY

Provided herein are systems and methods for roll-to-roll deposition of membrane electrode assemblies (MEAs) and layers thereof. Also provided herein are the ink formulation for or roll-to-roll deposition of membrane electrode assemblies (MEAs) and layers thereof.

One aspect of the disclosure relates to an ink formulation for producing an anion-exchange membrane for a carbon oxide electrolyzer by a roll-to-roll process. The ink formulation includes one or more poly(m-terphenyl) ionic polymers, a solvent mixture, and an optional additive, where the poly(m-terphenyl) concentration is at least 10% w/v of the formulation.

Implementations may include one or more of the following features. In some embodiments, the ink formulation has a viscosity of about 150 cp to about 250 cp.

In some embodiments, the solvent mixture includes one or more polar aprotic solvents and one or more linear alcohols. In some embodiments, the solvent mixture is a 1:1 v/v mixture of cyclopentanone and n-propyl alcohol. In some embodiments, the solvent mixture is a pure solvent. The solvent mixture includes one or more of dimethyl sulfoxide, ethanol, ethyl acetate, n-propyl alcohol, allyl alcohol, toluene, cyclopentanone, cyclohexanone, dimethylformamide, acetonitrile, methanol, 1-propanol, 1-butanol, and acetone.

In some embodiments, the optional additive is a polyalcohol. The polyalcohol includes a poly(ethylene glycol) and a poly(vinyl alcohol).

In some embodiments, the ink formulation further includes a binder polymer. The binder polymer may be a sulfonated tetrafluoroethylene-based fluoropolymer-copolymer.

In some embodiments, the ink formulation further includes inert particles. The inert particles include one or more of polytetrafluoroethylene, clay, fibers, glass, titanium dioxide, silica, zirconia, and alumina.

In some embodiments, the ink formulation is filtered to remove large particulates.

In some embodiments, the poly(m-terphenyl) ionic polymer further includes a counter ion. The counter includes one or more of bicarbonate, halides, oxyanions, fluorophosphate anions, triflimidates, and metal halides. The polymer is a cross-linked poly(m-terphenyl) polymer.

Another aspect of the disclosure relates to a method of roll-to-roll deposition of an anion-exchange membrane for a carbon oxide electrolyzer. The method includes providing a substrate, providing a roll-to-roll coater having an adjustable slot die and one or more drying ovens, delivering the ink formulation to the roll-to-roll coater, coating the ink formulation to the substrate to form the anion-exchange membrane, where the roll-to-roll coater is configured to control an ink flow rate, a roller line speed, and the drying oven temperature.

In some embodiments, the ink formulation used for the roll-to-roll deposition method is free of air bubbles. In some embodiments, the anion-exchange membrane has a thickness of less than 25 μm. In some embodiments, the anion-exchange membrane has a thickness greater than 10 μm.

In some embodiments, the substrate is a flexible plastic substrate. In some embodiments, the substrate is exposed to corona treatment. In some embodiments, the substrate is exposed to plasma treatment. In some embodiments, the substrate further includes a release layer.

### BRIEF DESCRIPTION OF DRAWINGS

FIG. 1 shows a schematic illustration of a carbon dioxide (CO₂) electrolyzer configured to receive water and CO₂ (e.g., humidified or dry gaseous CO₂) as a reactant at a cathode and expel carbon monoxide (CO) as a product.

FIG. 2 shows a schematic illustration of a method of fabricating a ¾ MEA involving a hot press to transfer an AEM to an anode half MEA (anode ½ MEA), thereby forming the ¾ MEA.

FIG. 3 shows a schematic illustration of a method of assembling an AEM and other layers to form an MEA involving a dry build.

FIG. 4 shows a schematic illustration of a method of assembling an MEA involving a spray deposition of the catalyst layer on the AEM.

FIG. 5 shows a schematic illustration of a method of assembling an MEA involving a direct transfer of the AEM and substrate to a ½ MEA and a hot press.

FIG. 6 shows a schematic illustration of a method of assembling an MEA that includes a carbon/Nafion interfacial layer.

### DETAILED DESCRIPTION

Provided herein are systems and methods for roll-to-roll deposition of membrane electrode assemblies (MEAs) and layers thereof. Embodiments of the systems and methods may be used for producing layers, including polymer electrolyte membranes (PEMs) and catalyst layers, of MEAs. In particular embodiments, the methods and systems may be used for producing anion-exchange membranes (AEMS). In other instances, the methods and systems may be used for producing cation-exchange membranes or bipolar membranes. Also provided are MEAs and layers thereof produced by the methods described herein. In some embodiments, the MEAs are configured for electrolysis and, in particular, for carbon oxide (COₓ) reduction. The methods and systems may also be employed for water electrolysis.

The roll-to-roll processing methods described herein may be used to fabricate membrane electrode assemblies and, in particular embodiments, MEAs for a carbon oxide (COₓ) reduction reactors. An MEA contains an anode layer, a cathode layer, an electrolyte, and optionally one or more other layers. The layers may include polymers such as ion-conducting polymers, one or more of which can be formed by roll-to-roll techniques.

COₓ may be carbon dioxide (CO₂), carbon monoxide (CO), CO₃²⁻ (carbonate ion), HCO₃⁻ (bicarbonate ion), or combinations thereof. When in use, the cathode of an MEA for a COₓ reduction reactor promotes electrochemical reduction of COₓ by combining three inputs: COₓ, ions (e.g., protons) that chemically react with COₓ, and electrons. The reduction reaction may produce CO, hydrocarbons, and/or oxygen and hydrogen containing organic compounds such as methanol, ethanol, and acetic acid. When in use, the anode of an MEA promotes an electrochemical oxidation reaction such as electrolysis of water to produce elemental oxygen and protons. The cathode and anode may each contain catalysts to facilitate their respective reactions.

The compositions and arrangements of layers in the MEA may promote high yield of a COₓ reduction products. To this end, the MEA may facilitate any one or more of the following conditions: (a) minimal parasitic reduction reactions (non-COₓ reduction reactions) at the cathode; (b) low loss of reactants at anode or elsewhere in the MEA; (c) maintain physical integrity of the MEA during the reaction (e.g., prevent delamination of the MEA layers); (d) prevent COₓ reduction product cross-over; (e) prevent oxidation production (e.g., O₂) cross-over; (f) maintain a suitable environment at the cathode/anode for oxidation/reduction as appropriate; (g) provide pathway for desired ions to travel between cathode and anode while blocking undesired ions; and (h) minimize voltage losses. One parasitic reaction can occur if oxygen produced at the anode diffuses to the cathode, where it can react with hydrogen to form water.

Polymer-based membrane assemblies such as MEAs have been used in various electrolytic systems such as water electrolyzers and in various galvanic systems such as fuel cells. However, COₓ reduction presents problems not encountered, or encountered to a lesser extent, in water electrolyzers and fuel cells.

For example, for many applications, an MEA for COₓ reduction requires a lifetime of about 50,000 hours or longer (approximately five years of continuous operation), which is significantly longer than the expected lifespan of a fuel cell for automotive applications; e.g., about 5,000 hours. And for various applications, an MEA for COₓ reduction employs electrodes having a large geometric surface area by comparison to MEAs used for fuel cells in automotive applications. For example, MEAs for COₓ reduction may employ electrodes having geometric surface areas (without considering pores and other nonplanar features) of at least about 500 cm².

COₓ reduction reactions may be implemented in operating environments that facilitate mass transport of particular reactant and product species, as well as to suppress parasitic reactions. Fuel cell and water electrolyzer MEAs often cannot produce such operating environments. For example, such MEAs may promote undesirable parasitic reactions such as gaseous hydrogen evolution at the cathode and/or gaseous CO₂ production at the anode.

### MEA Overview

In certain embodiments, an MEA has a cathode layer, an anode layer, and a polymer electrolyte membrane (PEM) between the anode layer and the cathode layer. The polymer electrolyte membrane provides ionic communication between the anode layer and the cathode layer, while preventing electronic communication, which would produce a short circuit. The cathode layer includes a reduction catalyst and a first ion-conducting polymer. The cathode layer may also include an ion conductor and/or an electron conductor. The anode layer includes an oxidation catalyst and a second ion-conducting polymer. The anode layer may also include an ion conductor and/or an electron conductor. The PEM includes a third ion-conducting polymer.

In certain embodiments, the MEA has a cathode buffer layer between the cathode layer and the polymer electrolyte membrane. The cathode buffer includes a fourth ion-conducting polymer. In certain embodiments, the MEA has an anode buffer layer between the anode layer and the polymer electrolyte membrane. The anode buffer includes a fifth ion-conducting polymer.

In connection with certain MEA designs, there are three available classes of ion-conducting polymers: anion-conductors, cation-conductors, and mixed cation-and-anion-conductors. The term “ion-conducting polymer” is used herein to describe a polymer electrolyte having greater than about 1 mS/cm specific conductivity for anions and/or cations. The term “anion-conductor” describes an ion-conducting polymer that conducts anions primarily (although there will still be some small amount of cation conduction) and has a transference number for anions greater than about 0.85 at around 100-micron thickness. The terms “cation-conductor” and/or “cation-conducting polymer” describe an ion-conducting polymer that conducts cations primarily (e.g., there can still be an incidental amount of anion conduction) and has a transference number for cations greater than approximately 0.85 at around 100-micron thickness. For an ion-conducting polymer that is described as conducting both anions and cations (a “cation-and-anion-conductor”), neither the anions nor the cations have a transference number greater than approximately 0.85 or less than approximately 0.15 at around 100-micron thickness. To say a material conducts ions (anions and/or cations) is to say that the material is an ion-conducting material or ionomer.

When all of the ion-conducting polymers in an MEA for CO₂ reduction are anion-conductors, then CO₂ reacts with hydroxide anions in the ion-conducting polymer at the cathode to form bicarbonate anions. The electric field in the reactor moves the bicarbonate anions from the cathode side of the cell to the anode side of the cell. At the anode, bicarbonate anions can decompose back into CO₂ and hydroxide. This results in the net movement of CO₂ from the cathode to the anode of the cell, where it does not react and is diluted by the anode reactants and products. This loss of CO₂ to the anode side of the cell reduces the efficiency of the process.

In certain embodiments, the roll-to-roll processes described herein are used to form anion-conducting layers for COₓ reduction reactors. The anion-conducting layers may be part of a bipolar MEA or an anion-exchange membrane (AEM)-only MEA. Alternatively, the roll-to-roll process described herein may be adapted to form cation-conduction layers for COₓ reduction reactors. The cation-conduction layers may be part of a bipolar MEA or cation-exchange membrane-only MEA.

### Bipolar MEA for COx Reduction

In certain embodiments, the MEA includes a bipolar interface with an anion-conducting polymer on the cathode side of the MEA and an interfacing cation-conducting polymer on the anode side of the MEA. In some implementations, the cathode contains a first catalyst and an anion-conducting polymer. In certain embodiments, the anode contains a second catalyst and a cation-conducting polymer. In some implementations, a cathode buffer layer, located between the cathode and PEM, contains an anion-conducting polymer. In some embodiments, an anode buffer layer, located between the anode and PEM, contains a cation-conducting polymer.

During operation, an MEA with a bipolar interface moves ions through a polymer-electrolyte, moves electrons through metal and/or carbon in the cathode and anode layers, and moves liquids and gas through pores in the layers.

In embodiments employing an anion-conducting polymer in the cathode and/or in a cathode buffer layer, the MEA can decrease or block unwanted reactions that produce undesired products and decrease the overall efficiency of the cell. In embodiments employing a cation-conducting polymer in the anode and/or in an anode buffer layer can decrease or block unwanted reactions that reduce desired product production and reduce the overall efficiency of the cell.

For example, at levels of electrical potential used for cathodic reduction of CO₂, hydrogen ions may be reduced to hydrogen gas. This is a parasitic reaction; current that could be used to reduce CO₂ is used instead to reduce hydrogen ions. Hydrogen ions may be produced by various oxidation reactions performed at the anode in a CO₂ reduction reactor and may move across the MEA and reach the cathode where they can be reduced to produce hydrogen gas. The extent to which this parasitic reaction can proceed is a function of the concentration of hydrogen ions present at the cathode. Therefore, an MEA may employ an anion-conducting material in the cathode layer and/or in a cathode buffer layer. The anion-conducting material at least partially blocks hydrogen ions from reaching catalytic sites on the cathode. As a result, parasitic production of hydrogen gas generation is decreased, and the rate of CO or other product production and the overall efficiency of the process are increased.

Another process that may be avoided is transport of carbonate or bicarbonate ions to the anode, effectively removing CO₂ from the cathode. Aqueous carbonate or bicarbonate ions may be produced from CO₂ at the cathode. If such ions reach the anode, they may decompose and release gaseous CO₂. The result is net movement of CO₂ from the cathode to the anode, where it does not get reduced and is lost with oxidation products. To prevent the carbonate and bicarbonate ion produced at the cathode from reaching the anode, the polymer-electrolyte membrane and/or an anode buffer layer may include a cation-conducting polymer, which at least partially blocks the transport of negative ions such as bicarbonate or carbonate ions to the anode.

Thus, in some designs, a bipolar membrane structure raises the pH at the cathode to facilitate CO₂ reduction while a cation-conducting polymer such as a proton-exchange layer prevents the passage of significant amounts of CO₂, negative ions (e.g. bicarbonate, carbonate), hydrogen, and CO₂ reduction products (e.g., CO, methane, ethylene, alcohols) to the anode side of the cell.

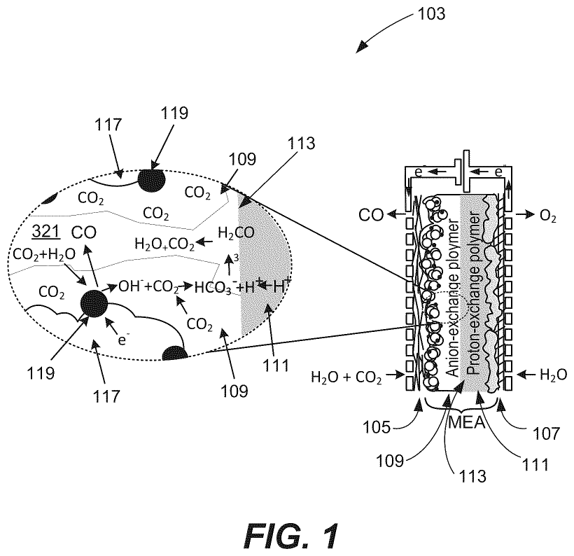

FIG. 1 shows CO₂ electrolyzer 103 configured to receive water and CO₂ (e.g., humidified or dry gaseous CO₂) as a reactant at a cathode 105 and expel CO as a product. Electrolyzer 103 is also configured to receive water as a reactant at an anode 107 and expel gaseous oxygen. Electrolyzer 103 includes bipolar layers having an anion-conducting polymer 109 adjacent to cathode 105 and a cation-conducting polymer 111 (illustrated as a proton-exchange membrane) adjacent to anode 107.

As illustrated in the magnification inset of a bipolar interface 113 in electrolyzer 103, the cathode 105 includes an anion exchange polymer (which in this example is the same anion-conducting polymer 109 that is in the bipolar layers) electronically conducting carbon support particles 117, and metal nanoparticles 119 supported on the support particles. CO₂ and water are transported via pores such as pore 121 and reach metal nanoparticles 119 where they react, in this case with hydroxide ions, to produce bicarbonate ions and reduction reaction products (not shown). CO₂ may also reach metal nanoparticles 119 by transport within anion exchange polymer 115.

Hydrogen ions are transported from anode 107, and through the cation-conducting polymer 111, until they reach bipolar interface 113, where they are hindered from further transport toward the cathode by anion exchange polymer 109. At interface 113, the hydrogen ions may react with bicarbonate or carbonate ions to produce carbonic acid (H₂CO₃), which may decompose to produce CO₂ and water. As explained herein, the resulting CO₂ may be provided in gas phase and should be provided with a route in the MEA back to the cathode 105 where it can be reduced. The cation-conducting polymer 111 hinders transport of anions such as bicarbonate ions to the anode where they could react with protons and release CO₂, which would be unavailable to participate in a reduction reaction at the cathode.

As illustrated, a cathode buffer layer having an anion-conducting polymer may work in concert with the cathode and its anion-conductive polymer to block transport of protons to the cathode. While MEAs employing ion conducting polymers of appropriate conductivity types in the cathode, the anode, cathode buffer layer, and if present, an anode buffer layer may hinder transport of cations to the cathode and anions to the anode, cations and anions may still come in contact in the MEA's interior regions, such as in the membrane layer.

As illustrated in FIG. 1, bicarbonate and/or carbonate ions combine with hydrogen ions between the cathode layer and the anode layer to form carbonic acid, which may decompose to form gaseous CO₂. It has been observed that MEAs sometime delaminate, possibly due to this production of gaseous CO₂, which does not have an easy egress path.

The delamination problem can be addressed by employing a cathode buffer layer having pores. One possible explanation of its effectiveness is that the pores create paths for the gaseous carbon dioxide to escape back to the cathode where it can be reduced. In some embodiments, the cathode buffer layer is porous but at least one layer between the cathode layer and the anode layer is nonporous. This can prevent the passage of gases and/or bulk liquid between the cathode and anode layers while still preventing delamination. For example, the nonporous layer can prevent the direct passage of water from the anode to the cathode. The porosity of various layers in an MEA is described further at other locations herein.

Anion-exchange membrane-only MEA for COx reduction

In some embodiments, an MEA does not contain a cation-conducting polymer layer. In such embodiments, the electrolyte is not a cation-conducting polymer and the anode, if it includes an ion-conducting polymer, does not contain a cation-conducting polymer. Examples are provided herein.

An anion-exchange membrane (AEM)-only (AEM-only) MEA allows conduction of anions across the MEA. In embodiments in which none of the MEA layers has significant conductivity for cations, hydrogen ions have limited mobility in the MEA. In some implementations, an AEM-only membrane provides a high pH environment (e.g., at least about pH 7) and may facilitate CO₂ and/or CO reduction by suppressing the hydrogen evolution parasitic reaction at the cathode. As with other MEA designs, the AEM-only MEA allows ions, notably anions such as hydroxide ions, to move through polymer-electrolyte. The pH may be lower in some embodiments; a pH of 4 or greater may be high enough to suppress hydrogen evolution. The AEM-only MEA also permits electrons to move to and through metal and carbon in catalyst layers. In embodiments, having pores in the anode layer and/or the cathode layer, the AEM-only MEA permits liquids and gas to move through pores.

In certain embodiments, an AEM-only MEA is used for CO₂ reduction. The use of an anion-exchange polymer electrolyte avoids low pH environment that disfavors CO₂ reduction. Further, water is transported away from the cathode catalyst layer when an AEM is used, thereby preventing water build up (flooding) which can block reactant gas transport in the cathode of the cell.

Water transport in the MEA occurs through a variety of mechanisms, including diffusion and electro-osmotic drag. In some embodiments, at current densities of the CO₂ electrolyzers described herein, electro-osmotic drag is the dominant mechanism. Water is dragged along with ions as they move through the polymer electrolyte. For a cation-exchange membrane such as Nafion membrane, the amount of water transport is well characterized and understood to rely on the pre-treatment/hydration of the membrane. Protons move from positive to negative potential (anode to cathode) with. each carrying 2-4 water molecules with it, depending on pretreatment. In anion-exchange polymers, the same type of effect occurs. Hydroxide, bicarbonate, or carbonate ions moving through the polymer electrolyte will ‘drag’ water molecules with them. In the anion-exchange MEAs, the ions travel from negative to positive voltage, so from cathode to anode, and they carry water molecules with them, moving water from the cathode to the anode in the process.

In certain embodiments, an AEM-only MEA is employed in CO reduction reactions. Unlike the CO₂ reduction reaction, CO reduction does not produce carbonate or bicarbonate anions that could transport to the anode and release valuable reactant.

Techniques such as ultrasonic spray deposition, doctor blade, and electrodeposition can be used to fabricate MEAs for COₓ electrolyzers. Roll-to-roll processing can provide advantages over such techniques including increased throughput and the ability to fabricate multi-layer and/or double-side coatings efficiently. However, there are challenges to developing ink formulations for certain polymers employed in COₓ electrolyzers. Ink formulations used in conventional spray coating techniques may not be appropriate.

### Roll-to-Roll Ink Formulations

In roll-to-roll processing, ink can be continuously coated on a flexible carrier substrate (also referred to as a web). For an MEA, the ink formulation is determined by the desired properties of the MEA layer and manufacturing considerations.

An ink formulation for a MEA layer of a COₓ electrolyzer may include a polymer, a solvent, and optional additives. In some embodiments, the polymer is an anion-conducting polymer. Such anion-conducting polymers may be employed as anion-exchange membranes (AEMs) of bipolar membranes or AEM-only membranes and/or used in catalyst layers as described. In other embodiments, the polymer is a cation-conducting polymer. Such cation-conducting polymers may be employed as cation-exchange membranes of bipolar membranes or cation-exchange membrane-only membranes and/or used in catalyst layers as described.

The polymer ink formulation is designed such that it possesses the chemical and physical characteristics necessary to form AEMs with target properties such as, but not limited to, a target thickness, uniformity, and transparency. The potential chemical and physical characteristics of the ink formulations that may be considered include uniformity or homogeneity of ink formulation, as well as the concentration of the mixture, presence of gas or air pockets, and viscosity.

In certain embodiments, polymers used in roll-to-roll processing are a family of poly(m-terphenyl) ionic polymers that are well-suited for COₓ electrolysis. Examples include, but are not limited to, poly(m-terphenyl trimethyl ammonium), poly(m-terphenyl methyl piperidinium), poly(m-terphenyl dipropyl methylamine), poly(m-terphenyl dimethyl hexylamine), poly(m-terphenyl dimethyl dodecylamine), poly(m-terphenyl methyl piperidinium)-random-poly(methyl m-terphenyl), poly(m-terphenyl trimethyl ammonium)-random-poly(methyl m-terphenyl), poly(m-terphenyl azoniaspiro [5,5]undecane), poly(m-terphenyl pyridium), poly(m-terphenyl dimethyl imidazolium), and combinations thereof.

In certain embodiments, polymers used in roll-to-roll processing are poly(p-terphenyl) ionic polymers. Examples include but are not limited to, poly(p-terphenyl trimethyl ammonium), oly (p-terphenyl methyl piperidinium), poly(p-terphenyl dipropyl methylamine), poly(p-terphenyl dimethyl hexylamine), poly(p-terphenyl dimethyl dodecylamine), poly(p-terphenyl methyl piperidinium)-random-poly(methyl p-terphenyl), poly(p-terphenyl trimethyl ammonium)-random-poly(methyl p-terphenyl), poly(p-terphenyl azoniaspiro [5,5]undecane), poly(p-terphenyl pyridium), poly(p-terphenyl dimethyl imidazolium), and combinations thereof.

In certain embodiments, polymers used in roll-to-roll processing are poly(o-terphenyl) ionic polymers. Examples include but are not limited to, poly(o-terphenyl trimethyl ammonium), oly (o-terphenyl methyl piperidinium), poly(o-terphenyl dipropyl methylamine), poly(o-terphenyl dimethyl hexylamine), poly(o-terphenyl dimethyl dodecylamine), poly(o-terphenyl methyl piperidinium)-random-poly(methyl o-terphenyl), poly(o-terphenyl trimethyl ammonium)-random-poly(methyl o-terphenyl), poly(o-terphenyl azoniaspiro [5,5]undecane), poly(o-terphenyl pyridium), poly(o-terphenyl dimethyl imidazolium), and combinations thereof.

In other embodiments, polymers used in roll-to-roll processing are a family of poly(biphenyl) ionic polymers. Examples include but are not limited to, poly(biphenyl trimethyl ammonium), poly(biphenyl methyl piperidinium), poly(biphenyl dipropyl methylamine), poly(biphenyl dimethyl hexylamine), poly(biphenyl dimethyl dodecylamine), poly(biphenyl methyl piperidinium)-random-poly(methyl biphenyl), poly(biphenyl trimethyl ammonium)-random-poly(methyl biphenyl), poly(biphenyl azoniaspiro [5,5]undecane), poly(biphenyl pyridium), poly(biphenyl dimethyl imidazolium), and combinations thereof.

In some embodiments, polymers used in roll-to-roll processing may be cross-linked polymers. Cross-linked polymers may mitigate the degradation of the layer in operation. Examples include but are not limited to, cross-linked poly(ethylene glycol), a poly(m-terphenyl), and combinations thereof. In various embodiments, poly(m-terphenyl) may necessarily contain a cross-linkable moiety to facilitate cross-linking of the poly(m-terphenyl). In various embodiments, the cross-linkable moiety may be any cross-linkable vinyl moiety, such as a styrene group. In another embodiment, the cross-linkable moiety may be acrylate and/or allyl. In alternative embodiments, combinations of two or more different poly(m-terphenyl) may be used. In some circumstances, all of the poly(m-terphenyl) may be cross-linked polymers, or at least one of the poly(m-terphenyl) is a cross-linked polymer.

In various embodiments, polymers used in roll-to-roll processing may be functionalized polymers. The polar functional group may be thiols, primary amines or secondary amines, hydroxyls, carboxylic, and combinations thereof. In various embodiments, polar functional groups may attach to the polymer via an alkyl chain. In certain embodiments, the alkyl chain may be a 6-, 8-, or 12-carbon chain. An example of functionalized polymer for roll-to-roll processing includes but is not limited to, a poly(m-terphenyl) polymer that contains a thiol functional group, functionalized via a 6-carbon alkyl chain. In other embodiments, functionalized polymer for roll-to-roll processing may be a poly(m-terphenyl) polymer that contains a thiol functional group, functionalized via a 12-carbon alkyl chain.

In other embodiments, the polymer used in roll-to-roll processing may be polymer-metal-organic-frameworks (poly-MOFs). Poly-MOFs are hybrid porous materials that comprise metal, metal ions, or metal clusters wherein the metallic species are coordinated with polymers that contain organic linkers to form one-, two-, or three-dimensional structures. A unique feature of the poly-MOFs in application to carbon oxide reduction is that the metal catalyst particles may be incorporated intrinsically into the polymer layer in the metal-organic frameworks. For example, gold nanoparticles (Au NPs) may be embedded into the poly-MOFs as a substitute for metal ions or metal clusters. In certain cases, the use of metals other than gold may promote unwanted side reactions.

Further description of polymers that may be employed according to various embodiments is provided below. Copolymers, including such polymers, may also be employed.

In some embodiments, a formulation may include multiple polymers. Combinations of polymers can provide access to membrane transport properties that are not attainable with a single polymer. For example, a combination of polymers can permit the incorporation of additional chemical moieties or microstructural features that impact the transport properties of the membrane. The membrane properties such as water update, ion transport, gas transport, or uncharged small molecule transport may be influenced. Moreover, a combination of polymers may allow the mechanical properties of the membranes to be modified. For example, the addition of polyalcohols, such as poly(ethylene glycol) and/or polyvinyl alcohol, may help with the wettability of the coating thereby improving the quality of the coating. A formulation may incorporate different polymers as mixtures or as copolymers.

In cases where a combination of two or more polymers is used, the solubility of each polymer should be considered, as it can be challenging to dissolve polymers in high concentrations. In particular, the poly(m-terphenyl) polymers can be especially challenging to dissolve at higher concentrations while dissolving other polymers such as poly(biphenyl) polymers may be more straightforward. Solubility is also considered when using copolymers.

In certain embodiments, additional polymers may be incorporated as binders. For instance, a 60:40 w/w mixture of poly(m-terphenyl) ionic polymer and a polymer with good binding properties, such as sulfonated tetrafluoroethylene-based fluoropolymer-copolymer (Nafion®), may be used.

In instances, one or more additives may be incorporated into the ink formulation. While the additives may not actively participate in cell performance, the additives may improve the wettability of the ink formulation on the substrate, thereby improving the coating of the membrane on a flexible plastic substrate. In some embodiments, additives may be used to tune the viscosity of the ink formulation. Additives may be polyalcohols. Examples of such additives include low molecular weight poly(ethylene glycol) (PEG 400) and poly(vinyl alcohol) (PVA). For example, ink formulation may be 2% w/v poly(ethylene glycol) and 16% w/v poly(m-terphenyl) ionic polymer, where the polymer is dissolved in 1:1 v/v cyclopentanone and n-propyl alcohol.

The polymer (and the additives) is dissolved in a solvent and/or a solvent mixture to create an ink formulation. The solvent and/or solvent mixture (referred to as solvent, a solvent mixture, or solvent matrix), may be a pure solvent or a combination of two or more solvents, such as a binary solvent mixture. A binary solvent mixture may improve the stability and crystallinity of the acceptor and form a better phase separation domain in coating techniques. Stable donor-acceptor phases prevent segregation over time. Phase segregation may have an undesirable impact on the imparted properties.

In some embodiments, the ink formulation may be a suspension including particulates. For example, as described further below, inert particles such as polytetrafluoroethylene (PTFE) may be incorporated into an ink formulation and the resulting MEA layer. As discussed further below, inert particles can be used to create porosity in a layer, which can be advantageous for COₓ electrolysis. In some embodiments, the inert particles may be inorganic inert filler particles such as clay, fibers, or glass. Other materials suitable as inert filler particles include but are not limited to, TiO₂, silica, zirconia, and alumina.

In certain embodiments, catalysts may be incorporated into the ink formulation. For example, catalyst particles (supported or unsupported) and, in some embodiments, support particles, may be added to the ink formulation. In this manner, a cathode catalyst layer may be formed by roll-to-roll processing. In some instances, a small amount of inert particles may be added to the ink formulation to improve the overall performance of the COₓ electrolyzers.

In certain embodiments, the solvent matrix is a pure solvent such as a polar aprotic solvent or a linear alcohol. The solvent matrix may incorporate volatile solvents to facilitate rapid drying time in the roll-to-roll processing of the membrane. Examples of polar aprotic solvents include, but are not limited to, dimethyl sulfoxide, dimethylformamide, cyclopentanone, cyclohexanone, acetonitrile, and acetone. Examples of linear alcohols include, but are not limited to, methanol, ethanol, 1-propanol, and 1-butanol. In other embodiments, the solvent matrix is a solvent mixture including a combination of a polar aprotic solvent and a linear alcohol.

In certain embodiments, a binary solvent mixture is used. Such binary solvent mixtures include dimethyl sulfoxide and ethanol, ethyl acetate and ethanol, dimethyl sulfoxide and n-propyl alcohol, allyl alcohol and n-propyl alcohol, toluene and ethanol, toluene and n-propyl alcohol, cyclopentanone and ethanol, cyclopentanone and n-propyl alcohol. In some embodiments, the binary solvent mixture has a volume ratio of 1 to 1. In some embodiments, the boiling points of the solvents in a binary solvent mixture are matched to avoid uneven evaporation and the resulting polymer particle agglomeration. In some embodiments, the solvents in a binary solvent mixture have boiling points within 40° C. degrees of each other. In certain cases, the different solvents in the binary solvent mixture may interact with one another, leading to the co-evaporation of solvents.

The solvent matrix selected for the ink to be used in roll-to-roll processing depends on a number of factors, such as (a) solubility of the polymer in a solvent matrix, (b) boiling point and relative vapor pressure of the solvents in the solvent matrix, (c) toxicity of the solvent matrix, and (d) compatibility with the substrate.

The solubility of the polymer (or combination of polymers) is such that a sufficient amount of polymer may be dissolved, producing a fluid formulation having an appropriate viscosity range without forming a polymer gel. A polymer can be dissolved, suspended, and/or mixed with the solvent matrix in any other suitable manner.

Appropriate viscosity range depends on the roll-to-roll process used. For example, in slot die coating, a viscosity range may be about 150 cP to about 250 cP.

The solid content or polymer concentration in the formulation is controlled to obtain a desired thickness and uniformity of the coating. Ink formulations having polymer concentrations that are too high can be too viscous to form a polymer gel instead of fluid ink. The ‘gelled’ ink can create issues during the roll-to-roll processing, for example, blockage of a slot die system. These issues can affect the quality of the coating. The ink formulation is curated to achieve the appropriate concentration level necessary to form the AEMs coating of the target thickness. In some embodiments, the target thickness of the resulting AEM coating that ensures optimal device performance may range from about 10-14 μm.

The boiling point of the solvent matrix determines the drying time of the ink once on the carrier substrate. In situations where the boiling point of the solvent is too high, a higher drying oven temperature in roll-to-roll processing may be used to properly dry the coated film. A high drying temperature can cause thermal degradation of the polymers in the coating. Ideally, the boiling point of the solvent matrix is sufficiently low such that a moderate temperature may be used to dry the ink. The upper limit for the boiling point may depend on the time the coated film spends in the dryer. In a particular example, a film may experience a short residence time in the dryer, such as less than 2 minutes. Under such circumstances, the maximum boiling temperature of 140° C. may be acceptable. And, as discussed above, in binary mixtures the boiling points may be matched to avoid agglomeration and uneven drying.

As indicated above, another aspect of solvent matrix selection is the toxicity of the solvent matrix. Solvents with low toxicity, such as cyclopentanone or n-propyl alcohol, may be used in roll-to-roll system to lower any potential risk to the operator. Examples of low-toxicity solvent matrixes include a 1:1 v/v mixture of cyclopentanone and n-propyl alcohol and a 1:1 v/v mixture of cyclopentanone and ethanol.

In some embodiments, a concentration of a poly(m-terphenyl) polymer in dimethyl sulfoxide may be less than 10% w/v. Above this concentration, the polymer may exhibit gelling. In many cases, a concentration above 10% w/v may be necessary to achieve desired thickness while maintaining the rheologic properties necessary for roll-to-roll processing.

In another embodiment, a concentration of a poly(m-terphenyl) polymer in a 1:1 v/v combination of dimethyl sulfoxide and ethanol is up to about 12.5%. Above 10% w/v concentration, the polymer may not be fully dissolved.

In certain embodiments, a concentration of a poly(m-terphenyl) polymer in a 1:1 v/v combination of dimethyl sulfoxide and n-propyl alcohol is between about 12% w/v and 13.5% w/v. At higher concentrations, gelling may occur and/or the polymer may not fully dissolve. At lower concentrations, the thickness of the resulting layer may not be sufficient or uniform.

Allyl alcohol may be useful as a lower boiling solvent than dimethyl sulfide. However, allyl alcohol may be avoided in some circumstances due to relatively high toxicity. In some embodiments, the concentration of a poly(m-terphenyl) polymer in a 1:1 v/v combination of allyl alcohol and n-propyl alcohol is about 13.5% w/v.

In some embodiments, a binary solvent mixture including toluene and a linear alcohol may be used. Such solvent mixtures can provide relatively high solubility of poly(m-terphenyl) polymers and low boiling points. Toluene may be avoided in some circumstances due to toxicity. Examples of linear polymers that may be used with toluene include ethanol and n-propyl alcohol. Concentration of a poly(m-terphenyl) polymer in a 1:1 v/v combination of toluene and ethanol may be up to 20%. In some embodiments, n-propyl alcohol may be used with toluene having a better matched boiling point. Concentration of a poly(m-terphenyl) polymer in a 1:1 v/v combination of toluene and n-propyl alcohol may be up to 20%.

In other embodiments, concentration is about 20% w/v in a 1:1 v/or n-propyl alcohol. In other embodiments, poly(m-terphenyl). polymer concentration is about 27% w/v in a 1:1 v/v combination of cyclopentanone, and ethanol or n-propyl alcohol. In certain embodiments, poly(m-terphenyl). polymer concentration is about 16% or 18% w/v in a 1:1 v/v combination of cyclopentanone and n-propyl alcohol. In other embodiments, poly(m-terphenyl). Polymer concentration is about 20% w/v, or about 22% w/v in a 1:1 v/v combination of cyclopentanone and ethanol.

In some embodiments, a binary solvent mixture including cyclopentanone or cyclohexanone and a linear alcohol may be used. Such solvent mixtures can provide relatively high solubility of poly(m-terphenyl) polymers and low boiling points. In some embodiments, cyclopentanone may be used as it has lower toxicity. Examples of linear polymers that may be used with cyclopentanone or cyclohexanone include ethanol and n-propyl alcohol. Concentration of a poly(m-terphenyl) polymer in a 1:1 v/v combination of cyclopentanone and ethanol may be up to 27% w/v. In some embodiments, n-propyl alcohol may be used with cyclopentanone as it provides a clear, uniform film.

Compared to an ink formulation for spray coating, a roll-to-roll ink formulation may contain larger particles. This is attributed to a higher concentration of roll-to-roll ink formulation than the spray-coated ink. For example, the concentration of ink formulation for roll-to-roll can about 10%, 13%, or 16% or higher whereas spray-coating ink formulation is about 2%. An ink formulation may be filtered to remove larger particle content. For example, a bag filter with a pore size of 25 μm may be used.

Further consideration of the solvent matrix and substrate selection is given to the compatibility of the solvent matrix and/or ink formulation with the carrier substrate. The choice of substrate can affect the quality of the coating. A substrate having similar surface energy as the ink formulation allows the ink formulation to wet the substrate effectively. Solvent matrix and ink formulation compatibility with the substrates may be assessed by measurements such as contact angle measurement of the ink on the substrate or by coating the membrane in a slot die system and examining for any visible defects. A surface energy measurement may also be performed. This is a sophisticated form of a contact angle measurement, involving applying a series of solutions of varying surface tensions to the surface. The surface energy is calculated from the known liquid surface tension and the measured contact angle. Other suitable measurements may be made, in conjunction or as an alternative to any of these, to determine the compatibility of the ink formulation with the substrate. Compatibility may be independently determined for different formulations in roll-to-roll processing of the AEMs and/or other MEA layers.

Additional considerations for the choice of substrate include whether the membrane can be peeled from the substrate. For COₓ electrolyzers, the coated layers may be thin enough that it can be challenging to remove them from the substrate and place them into the cell. In certain embodiments, the substrate may include a thin “release layer” of silicon, or other materials, designed for easy release of the membrane. However, there is a potential for silicon to transfer to the membrane. Substrate poisoning may be another consideration when choosing the substrate for roll-to-roll formulation.

In some embodiments, the substrate is a flexible plastic. Examples include polyethylene terephthalate and ethylene tetrafluoroethylene. In certain embodiments, polyethylene terephthalate has a silicon release layer. The release layer may facilitate easy release of the membrane from the substrate. The substrates may be pre-treated to improve compatibility with the formulation. In certain embodiments, the substrate may be treated with plasma treatment or corona treatment. In another embodiment, a wetting agent may be added to improve compatibility. In some embodiments, corona treatment of the substrate may be conducted at powers between about 0.77 kW and 1.00 kW. A system for the pre-treatment of a substrate can be incorporated into the roll-to-roll machine.

### Anion-Conducting Polymers

As described above, the roll-to-roll formulations and methods described herein may be used to form AEM layers in some embodiments. The anion-conducting polymers include arylene-containing backbones, which provide an organic scaffold upon which ionizable/ionic moieties can be added.

An arylene-containing backbone can also provide an aromatic group that facilitates the addition of a reactive carbocation (e.g., by reacting with a Friedel-Crafts alkylation reagent). In this way, monomeric units having aromatic groups can be reacted together to form a polymeric unit. Such addition/polymerization reactions can be promoted in any useful manner, e.g., by including an electron-withdrawing group in proximity to that carbocation. Thus, in some non-limiting instances, the anion-conducting polymer can include both optionally substituted aromatic groups and electron-withdrawing groups. The reactive carbocation can also provide functional groups that can be further modified. For instance, the reactive carbocation can be attached to a-L^{A}-RG group, in which L^{A} is a linking moiety (e.g., any herein) and RG is a reactive group (e.g., halo). After adding the carbocation and -L^{A}-RG group to the polymeric unit, the RG group can be further reacted with an ionizable reagent (e.g., such as an amine, NR^{N1}R^{N2}R^{N3}) to provide an ionic moiety (e.g., such as an ammonium, —N⁺R^{N1}R^{N2}R^{N3}).

Accordingly, in some non-limiting embodiments, the anion-conducting polymer includes a polymeric unit (e.g., any described herein) having an ionizable/ionic moiety and an electron-withdrawing group. In some instances, the polymeric unit is formed by using one or more monomeric units. Non-limiting monomeric units can include one or more of the following:

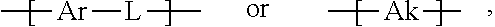

in which Ar is an optionally substituted arylene or optionally substituted aromatic; Ak is an optionally substituted alkylene, optionally substituted haloalkylene, optionally substituted heteroalkylene, optionally substituted aliphatic, or optionally substituted heteroaliphatic; and L is a linking moiety (e.g., any described herein) or can be —C(R⁷)(R⁸)— (e.g., for any R⁷ and R⁸ groups described herein). In particular examples, Ar, L, and/or Ak can be optionally substituted with one or more ionizable or ionic moieties and/or one or more electron-withdrawing groups.

In some embodiments, the anion-conducting polymer includes a polymeric unit selected from the following:

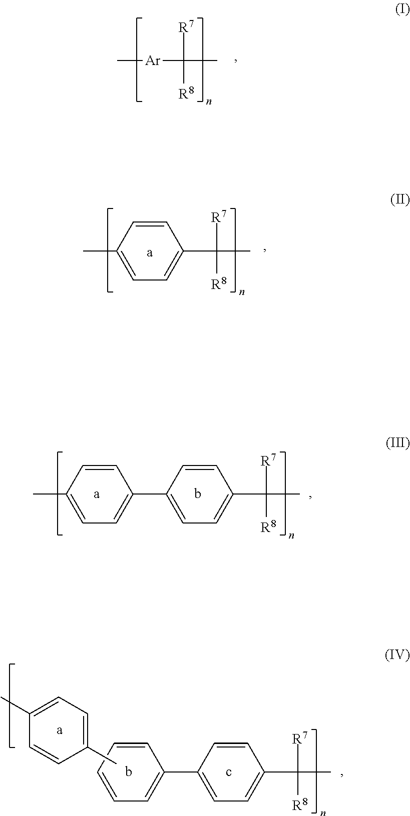

and a salt thereof, wherein:
each of R⁷ and R⁸ is, independently, an electron-withdrawing moiety, H, optionally substituted aliphatic, optionally substituted alkyl, optionally substituted heteroaliphatic, optionally substituted heteroalkyl, optionally substituted aromatic, optionally substituted aryl, or optionally substituted arylalkylene, wherein at least one of R⁷ or R⁸ includes the electron-withdrawing moiety or wherein R⁷ and R⁸ can be taken together to form an optionally substituted cyclic group; Ar comprises or is an optionally substituted aromatic or optionally substituted arylene (e.g., any described herein); each of n is, independently, an integer of 1 or more; each of ring a, ring b, and/or ring c can be optionally substituted; and wherein one or more of rings a-c, R⁷, and R⁸ can optionally include an ionizable moiety or an ionic moiety.

Further substitutions for ring a, ring b, ring c, R⁷, and R⁸ can include one or more optionally substituted arylene, as well as any described herein for alkyl or aryl. Non-limiting examples of Ar include, e.g., phenylene (e.g., 1,4-phenylene, 1,3-phenylene, etc.), biphenylene (e.g., 4,4′-biphenylene, 3,3′-biphenylene, 3,4′-biphenylene, etc.), terphenylene (e.g., 4,4′-terphenylene), triphenylene, diphenyl ether, anthracene (e.g., 9,10-anthracene), naphthalene (e.g., 1,5-naphthalene, 1,4-naphthalene, 2,6-naphthalene, 2,7-naphthalene, etc.), tetrafluorophenylene (e.g., 1,4-tetrafluorophenylene, 1,3-tetrafluorophenylene), and the like, as well as others described herein.

The anion-conducting polymer can include polymeric units having an electron-withdrawing moiety and a fluorenyl-based backbone. For instance, the anion-conducting polymer can include a polymeric unit as follows:

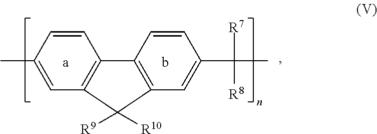

or a salt thereof, wherein:
each of R⁷ and R⁸ is, independently, an electron-withdrawing moiety, H, optionally substituted aliphatic, optionally substituted alkyl, optionally substituted heteroaliphatic, optionally substituted heteroalkyl, optionally substituted aromatic, optionally substituted aryl, or optionally substituted arylalkylene, wherein at least one of R⁷ or R⁸ includes the electron-withdrawing moiety or wherein R⁷ and R⁸ can be taken together to form an optionally substituted cyclic group;
each of R⁹ and R¹⁰ is, independently, H, optionally substituted aliphatic, optionally substituted alkyl, optionally substituted heteroaliphatic, optionally substituted heteroalkyl, optionally substituted aromatic, optionally substituted aryl, or optionally substituted arylalkylene, or wherein R⁹ and R¹⁰ can be taken together to form an optionally substituted cyclic group; n is, independently, an integer of 1 or more; each of ring a, ring b, and/or ring c can be optionally substituted; and wherein one or more of rings a-b, R⁷, R⁸, R⁹, and R¹⁰ can optionally include an ionizable moiety or an ionic moiety.

In particular embodiments, each of R⁹ and R¹⁰ includes, independently, an ionizable/ionic moiety.

In some embodiments (e.g., of formulas (I)-(V)), ring a, ring b, and/or ring c includes an ionizable moiety or an ionic moiety. In other embodiments, R⁸ includes an ionizable moiety or an ionic moiety. In particular embodiments, the ionic moiety includes or is -L^{A}-X^{A}, in which L^{A} is a linking moiety (e.g., optionally substituted aliphatic, alkylene, heteroaliphatic, heteroalkylene, aromatic, or arylene); and X^{A} is an acidic moiety, a basic moiety, a multi-ionic moiety, a cationic moiety, or an anionic moiety. Non-limiting examples of X^{A} include amino, ammonium cation, heterocyclic cation, piperidinium cation, azepanium cation, phosphonium cation, phosphazenium cation, or others herein.

In other embodiments (e.g., of formulas (I)-(V)), R⁷ includes the electron-withdrawing moiety. Non-limiting electron-withdrawing moieties can include or be an optionally substituted haloalkyl, cyano (CN), phosphate (e.g., —O(P═O) (OR^{P1})(OR^{P2}) or —O—[P(═O)(OR^{P1})—O]_{P3}-R^{P2}), sulfate (e.g., —O—S(═O)₂(OR^{S1})), sulfonic acid (—SO₃H), sulfonyl (e.g., —SO₂—CF₃), difluoroboranyl (—BF₂), borono (—B(OH)₂), thiocyanato (—SCN), or piperidinium. In further embodiments, R⁷ includes the electron-withdrawing moiety, and R⁸ includes the ionizable/ionic moiety. Yet other non-limiting phosphate groups can include derivatives of phosphoric acid, such as orthophosphoric acid, pyrophosphoric acid, tripolyphosphoric acid, tetrapolyphosphoric acid, trimetaphosphoric acid, and/or phosphoric anhydride, or combinations thereof.

In some embodiments (e.g., for any structure herein, such as in formulas (I)-(V)), R⁷ includes an optionally substituted aliphatic group. In one embodiment, R⁷ includes an optionally alkyl group.

In other embodiments (e.g., for any structure herein, such as in formulas (I)-(V)), R⁸ includes an optionally substituted aliphatic group or an optionally substituted heteroaliphatic group. In particular embodiments, the aliphatic or heteroaliphatic group is substituted with an oxo group (═O) or an hydroxyimino group (═N—OH). In one embodiment, R⁸ is —C(═X)—R⁸′, in which X is O or N—OH; and R⁸′ is optionally substituted aliphatic, optionally substituted alkyl, optionally substituted heteroaliphatic, optionally substituted heteroalkyl, optionally substituted alkoxy, optionally substituted haloalkyl, or optionally substituted alkanoyl.

In yet other embodiments (e.g., for any structure herein, such as in formulas (I)-(V)), R⁷ and R⁸ are taken together to form an optionally substituted cyclic group. For instance, R⁷ and R⁸ can be taken together to form an optionally substituted spirocyclyl group, as defined herein. In particular embodiments, the spirocyclyl group is substituted, independently, with one or more ionizable moieties or ionic moieties (e.g., any described herein). In some embodiments, the formulas of (I)-(V) can be represented as follows:

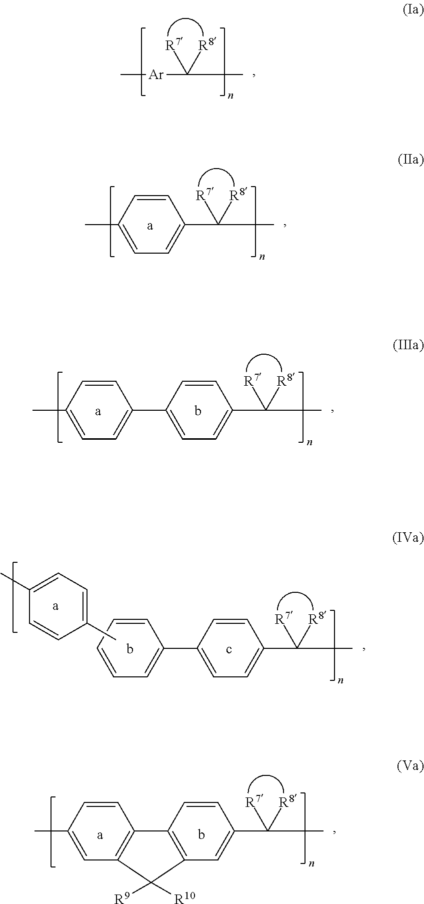

or a salt thereof,
wherein R⁷′ and R⁸′ are taken together to form an optionally substituted alkylene group or an optionally substituted heteroalkylene group. In particular embodiments, the optionally substituted alkylene group or the optionally substituted heteroalkylene group is substituted, independently, with one or more ionizable moieties or ionic moieties.

Further non-limiting polymeric units can include a structure of any one or more of the following:

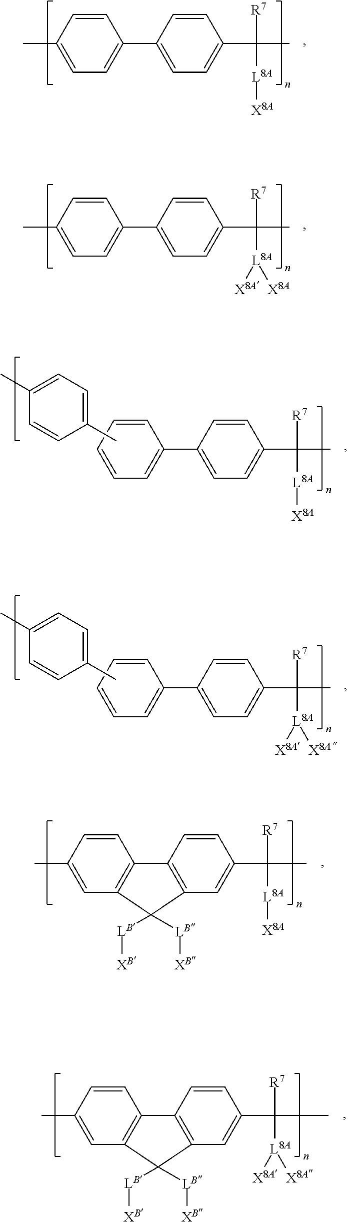

or a salt thereof, wherein:
n is from 1 or more; each L^{8A}, L^{B}′, and L^{B}″ is, independently, a linking moiety; and each X^{8A}, X^{8A}′, X^{8A}″, X^{B}′, and X^{B}″ is, independently, an acidic moiety or a basic moiety.

In any embodiment herein, ring a, ring b, ring c, Ak, R⁷, R⁸, R⁹, and R¹⁰ can optionally include an ionizable moiety or an ionic moiety. Further substitutions for ring a, ring b, ring c, R⁷, R⁸, R⁹, and R¹⁰ can include one or more optionally substituted arylene.

In any embodiment herein, the electron-withdrawing moiety can be an optionally substituted haloalkyl (e.g., C₁₋₆ haloalkyl, including halomethyl, perhalomethyl, haloethyl, perhaloethyl, and the like), cyano (CN), phosphate (e.g., —O(P═O)(OR^{P1}) (OR^{P2}) or —O—[P(═O)(OR^{P1})—O]_{P3}—R^{P2}), sulfate (e.g., —O—S(═O)₂(OR^{S1})), sulfonic acid (—SO₃H), sulfonyl (e.g., —SO₂—CF₃), difluoroboranyl (—BF₂), borono (B(OH)₂), thiocyanato (—SCN), or piperidinium. Yet other non-limiting phosphate groups can include derivatives of phosphoric acid, such as orthophosphoric acid, pyrophosphoric acid, tripolyphosphoric acid, tetrapolyphosphoric acid, trimetaphosphoric acid, and/or phosphoric anhydride, or combinations thereof.

In some embodiments (e.g., for any structure herein, such as in formulas (I)-(V)), non-limiting haloalkyl groups include fluoroalkyl (e.g., —CₓF_{y}H_{z}), perfluoroalkyl (e.g., —CₓF_{y}), chloroalkyl (e.g., —CₓCl_{y}H_{z}), perchloroalkyl (e.g., —CₓCl_{y}), bromoalkyl (e.g., —CₓBr_{y}H_{z}), perbromoalkyl (e.g., —CₓBr_{y}), iodoalkyl (e.g., —CₓI_{y}H_{z}), or periodoalkyl (e.g., —CₓI_{y}). In some embodiments, x is from 1 to 6, y is from 1 to 13, and z is from 0 to 12. In particular embodiments, z=2x+1-y. In other embodiments, x is from 1 to 6, y is from 3 to 13, and z is 0 (e.g., and y=2x+1).

The polymeric unit can include one or more substitutions to a ring portion of the unit (e.g., as provided by an aromatic or arylene group) or to a linear portion (e.g., as provided by an aliphatic or alkylene group). Non-limiting substitutions can include lower unsubstituted alkyl (e.g., C₁₋₆ alkyl), lower substituted alkyl (e.g., optionally substituted C₁₋₆ alkyl), lower haloalkyl (e.g., C₁₋₆ haloalkyl), halo (e.g., F, Cl, Br, or I), unsubstituted aryl (e.g., phenyl), halo-substituted aryl (e.g., 4-fluoro-phenyl), substituted aryl (e.g., substituted phenyl), and others.

Any of the polymeric units above may be in a copolymer. Examples of copolymers are described in U.S. Patent Application No. 17,451,628, filed Oct. 20, 2021, and incorporated by reference herein.

### Crosslinking

In some embodiments, crosslinking is present within an ion conducting polymer layer and/or between ion conducting polymer layers. Crosslinking within a material can be promoted by use of crosslinking reagents. For instance, the composition can include polymeric units, and a crosslinking reagent can be used to provide crosslinking between polymeric units. For instance, if the polymeric units (P1 and P2) include a leaving group, then a diamine crosslinking reagent (e.g., H₂N-Ak-NH₂) can be used to react with the polymeric units by displacing the leaving group and forming an amino-containing crosslinker within the composition (e.g., thereby forming P1 —NH-Ak-NH—P₂). Crosslinkers can be introduced by forming a polymer composition and then exposing the composition to a crosslinking reagent to form crosslinker.

Depending on the functional group present in the material, the crosslinking reagent can include a nucleophilic group (e.g., an amine or a hydroxyl) or an electrophilic group (e.g., a carbonyl). Thus, non-limiting crosslinking reagents can include amine-containing reagents, hydroxyl-containing reagents, carboxylic acid-containing reagents, acyl halide-containing reagents, or others. Further crosslinking reagents can include:

Ak [symbol] X]_{L3} or Ar [symbol] X]_{L3} Ar [symbol] L-X]_{L3}, in which Ak is an optionally substituted aliphatic or alkylene; Ar is an optionally substituted aromatic or arylene; L is a linking moiety (e.g., any herein, such as a covalent bond, optionally substituted alkylene, aliphatic, etc.); L3 is an integer that is 2 or more (e.g., 2, 3, 4, 5, 6, or more); and X is halo, hydroxyl, optionally substituted amino (e.g., NR^{N1}R^{N2}, in which each of R^{N1} and R^{N2} is, independently, H or optionally substituted alkyl), hydroxyl, carboxyl, acyl halide (e.g., —C(O)—R, in which R is halo), carboxyaldehyde (e.g., —C(O)H), or optionally substituted alkyl. Non-limiting crosslinking reagents can include terephthalaldehyde, glutaraldehyde, ortho-xylene, para-xylene, meta-xylene, or a multivalent amine, such as diamine, triamine, tetraamine, pentaamine, etc., including 1,6-diaminohexane (hexanediamine), 1,4-diaminobutane, 1,8-diaminooctane, propane-1,2,3-triamine, [1,1′:3′,1″-terphenyl]-4,4″,5′-triamine, and others.

After reacting the crosslinking reagent, the composition can include one or more crosslinkers within the composition. If the crosslinking reagent is bivalent, then a crosslinker can be present between two of any combination of polymeric structures, polymeric units, and ionizable/ionic moieties (e.g., between two polymeric units, between two ionizable/ionic moieties, etc.). If the crosslinking reagent is trivalent or of higher n valency, then the crosslinker can be present between any n number of polymeric units, linking moieties, ionizable moieties, and/or ionic moieties. Non-limiting crosslinkers present in the composition include those formed after reacting a crosslinking reagent. Thus, examples of crosslinkers can include:
Ak [symbol] X′]_{L3} or Ar [symbol] X′]_{L3} Ar [symbol] L-X′]_{L3}, in which Ak is an optionally substituted aliphatic or an optionally substituted alkylene, Ar is an optionally substituted aromatic or an optionally substituted arylene, L is a linking moiety (e.g., any herein, such as a covalent bond, optionally substituted alkylene, optionally substituted aliphatic, etc.), L3 is an integer that is 2 or more (e.g., 2, 3, 4, 5, 6, or more), and X′ is a reacted form of X. In some embodiments, X′ is absent,—O—, —NR^{N1}—, —C(O)—, or -Ak-, in which R^{N1} is H or optionally substituted alkyl, and Ak is optionally substituted alkylene, optionally substituted heteroalkylene, optionally substituted aliphatic, or optionally substituted heteroaliphatic.

### Roll-to-Roll Processing of the Ink Formulations

Prior to the roll-to-roll processing, an ink formulation may be degassed and/or sonicated in a bath to remove any air bubbles present in the solution. Alternatively, nitrogen blanketing may be used as a strategy to remove air from the ink formulation prior to delivering it to a slot die system or other appropriate system of a roll-to-roll apparatus.

Once the ink formulation is prepared, it may be coated on the substrate via a roll-to-roll processing method. Any commercially available roll-to-roll processing apparatus may be used, or it can be performed using a custom industrial or laboratory apparatus. Example roll-to-roll coaters include Mini-Labo Deluxe™ (Yasui Seiki), TecMaster (Faustel), FOM sigma (FOM technologies), and Smartcoater (Coatema).

A roll-to-roll apparatus generally includes a roll module, a coating module, and optionally a control module. The roll module tenses and moves the web and may also contain a drying system. The coating module is a part of the roll-to-roll instrument that performs the coating of the ink. In some embodiments, the coating module may include a slot die system. In other instances, it may include a blade coating system, a gravure coating system, a kiss coating system, or any other suitable coating system. The control module can regulate various processing parameters such as web speed, oven temperatures, as well as any other relevant processing parameters. It may include a user interface.

A roll module can include an unwinder roll to unwind the substrate, a rewinder roll to wind it back up, and a backing roll that carries the web through the system. The speed at which the rolls move may be set to desired value. In certain embodiments, the roll-to-roll system may have a plurality of roller units, for example, at least 2-rollers, 3-rollers, or 5-rollers. In many embodiments, the roll module includes an oven or a plurality of ovens. The oven or ovens generally function to remove any excess solvents in the ink formulation. The oven may be used to remove the excess organic solvent and alternatively may be used to remove the aqueous solvent. The length of the ovens may differ depending on the choice of the instrument. In one embodiment, the oven may be at least 1 meter long. In another embodiment, the system may incorporate at least two ovens or at least 3 ovens, where each oven may be at least 1 meter long. In other instances, the drying oven may be in inert condition, a floatation drying oven, or an electrical hot air dryer.

Additionally, the roll module may include additional feature units such as a corona treatment unit, a plasma treatment unit, and/or an ultraviolet treater unit. For example, a corona treatment unit treats the substrate before the ink is coated to reduce surface energy, which may, in turn, improve the quality of the coating. In some embodiments, the corona treatment add-on extension is a commercially available unit. The add-on extension unit may also include an ultraviolet treater for performing ultraviolet curing of the membrane. Ultraviolet curing may be performed to induce cross-linking of the polymer membrane. The roll module may include other treatment units such as near-infrared or infrared treatment units. In other instances, add-on extensions may include laminating units, interleaf peeler units, or VOC cover units.

A slot die system coating module may include a container or a syringe to store the ink, depending on the batch size of the ink, and a pump. The pump system is used to feed the ink from the storage system into the slot die. Once the cavity of the slot die is filled, it may deposit the ink onto the moving web at a flow rate, which may be manually set. In some cases, the roll-to-roll processing is done in a hot melt slot die or in a vacuum box. The coating module may be configured to perform roll-to-roll processing of the membrane in various manners including single-sided coating, dual-sided coating in a tension-over-web-slot die configuration, multi-layer or single-layer slot die curtain coating, or patch coating. The coating module may also have dividers.

In an example system, a slot die Mini-Labo Deluxe instrument equipped with two 1-meter-long drying ovens, a corona treater, and an ultraviolet curing system may be used for roll-to-roll processing of the AEMs.

The processing parameters be controlled to alter the quality of the resulting membrane. Different processing parameters in the roll-to-roll coating may influence the thickness of the membranes. The different processing conditions may produce membranes with varying thicknesses, transparencies, morphologies, extents of dryness, and defects. In some embodiments, the roll-to-roll coating may produce an anion-exchange membrane with a thickness of at least about 10 μm. In other embodiments, the roll-to-roll coating may produce an anion-exchange membrane with a thickness of less than 25 μm.

Morphological features that can characterize a film can include the texture, uniformity of thickness, uniformity of surface texture, and the presence or absence of any air bubbles, pinholes, and patchiness. In some embodiments, the ink formulation and processing conditions produce a smooth, uniform film without any air bubbles, pinholes, and patchiness. Processing conditions may also influence the extent of solvent evaporation thereby producing varying degrees of wet-to-dry membranes.

Tunable processing parameters include the flow rate of the ink, roller line speed, drying oven temperatures, slot die gap, and air pressure. Optimal slot die parameters such as flow rate, web speed, wet ink density, and dry ink/membrane density, may be mathematically determined to achieve a desired dried membrane thickness and/or loading.

The ink formulation forms a meniscus between the slot die tip and the substrate. A set of conditions that allows a stable meniscus should provide a good coating of the ink formulation onto the web.

Processing conditions will depend on the particular apparatus and formulation used. Example ink flow rates are between about 10 mL/min to about 25 mL/min. Example roller line speeds are between about 0.5 m/min to about 1.5 m/min. In certain embodiments, the roller line speed of the coating roll and drying roll may be different. For example, the line speeds of the coating roller and drying roller may be 1.0 m/min and 0.4 m/min, respectively.

The temperatures for the drying oven are chosen to adequately remove excess solvent from the coating process. The drying oven temperature can be between about 40° C. to about 60° C., or 80° C. to about 100° C., or about 120° C. to about 150° C. In embodiments where the plurality of ovens is used, each drying oven may adopt the same or different temperatures. In one example, the first and second drying oven temperatures may be 60° C. and 140° C., respectively. In another example, the first oven temperature is 50° C. and the second oven temperature is 140° C.

A slot die gap may be set using a 250 μm or 254 μm shim and Teflon gasket such as a 200 μm thick Teflon strip, which controls the opening of the slot die lip. In an embodiment, the slot die width is 150 mm, assembled using a 250 μm metal shim and torqued to 250 N/m. The distance between the slot die and substrate can range from about 100 μm to about 400 μm. In certain embodiments, the slot die distance is about 92 μm, about 136 μm, about 164 μm, or about 210 μm.

Air pressure may also be varied in the roll-to-roll processing of the membranes. In some embodiments, it may range from about 0.015 MPa to about 0.030 MPa. Alternatively, the roll-to-roll coating method may be performed in a vacuum or near vacuum condition. In other instances, the roll-to-roll coating method may be performed in atmospheric conditions.

### EXAMPLES

In a first example, an ink formulation of 18% w/v concentration of poly(7,7,7-trifluoro-N,N,N,6-tetramethyl-6-(4″-methyl-[1,1′:3′,1″-terphenyl]-4-yl) heptan-1-aminium) in about 1:1 v/v mixture of cyclopentanone and the 1-propanol solvent matrix was used to produce an AEM via a roll-to-roll technique using a Mini-Labo Deluxe roll coater having two, 1-meter-long drying ovens equipped with a corona treater. The ink formulation was visibly uniform.

The ink formulation was degassed via bath sonication to remove any air bubbles and filtered using a 25 μm pore size bag filter. This ink formulation was subsequently used to produce an AEM via the roll-to-roll method. The membrane was coated on an 8″ poly plastic film substrate pre-processed with corona treatment at 0.77 kW. Processing conditions include an ink flow rate of 11.77 mL/min, a line speed of 1.0 m/min, a die gap set at 92 μm, and the first oven temperature is 60° C., and the second oven temperature is 140° C. The resulting membrane had a mean thickness between 13 μm and 14 μm with the appearance of a slight orange peel texture.

In some embodiments, poly(7,7,7-trifluoro-N,N,N,6-tetramethyl-6-(4″-methyl-[1,1′:3′,1″-terphenyl]-4-yl) heptan-1-aminium) may have a counterion. Examples of counter ions include, but are not limited to, a class of halides, oxyanions such as oxocarbons, fluorophosphate anions, triflimidates, and/or metal halides. In various embodiments, counter ions may be bicarbonate (HCO₃″), chloride (Cl⁻), bromide (Br⁻), hydroxide (OH⁻), or iodide (I⁻). For instance, poly(7,7,7-trifluoro-N,N,N,6-tetramethyl-6-(4″-methyl-[1,1′:3′,1″-terphenyl]-4-yl) heptan-1-aminium) may have a bicarbonate counterion. The bicarbonate counterion may be changed to another counterion via ion exchange procedure.

In a second example, an ink formulation of 18% w/v concentration of poly(7,7,7-trifluoro-N,N,N,6-tetramethyl-6-(4″-methyl-[1,1′:3′,1″-terphenyl]-4-yl) heptan-1-aminium) in about 1:1 v/v mixture of cyclopentanone and 1-propanol solvent matrix was used to produce an AEM. The same process as in described with reference to the previous example was used with the exception of a first oven temperature of 50° C. The resulting membrane had a mean thickness between 13 μm and 14 μm with a reduced appearance of orange peel texture compared to the previous embodiment.

In a third example, an ink formulation of 18% w/v concentration of poly(7,7,7-trifluoro-N,N,N,6-tetramethyl-6-(4″-methyl-[1,1′:3′,1″-terphenyl]-4-yl) heptan-1-aminium) in about 1:1 v/v mixture of cyclopentanone and the 1-propanol solvent matrix was used to produce and AEM. The ink formulation preparation process and substrate preparation process described in the above examples were used. To coat, a flow rate of 15.13 mL/min, a line speed of 1.0 m/min, a die gap set at 92 μm, a first oven temperature of 50° C., a second oven temperature of 140° C. were used. The resulting membrane had a thickness of about 17-19 μm with the appearance of slight texture but otherwise uniform defect-free film.

In a fourth example particular embodiment, an ink formulation of 18% w/v concentration of poly(7,7,7-trifluoro-N,N,N,6-tetramethyl-6-(4″-methyl-[1,1′:3′,1″-terphenyl]-4-yl) heptan-1-aminium) in about 1:1 v/v mixture of cyclopentanone and 1-propanol solvent matrix was used to produce AEM. The ink formulation preparation process and substrate preparation process described in the above examples were used. To coat, a flow rate of 20.47 mL/min, a line speed of 1.0 m/min, a die gap set at 92 μm, a first oven temperature of 50° C., and a second oven temperature of 140° C. were used. The resultant membrane had a mean thickness of 25 μm. This set of conditions produced a membrane with a uniform but possibly slightly wet coating.

In fifth example, an ink formulation of 18% w/v concentration of poly(7,7,7-trifluoro-N,N,N,6-tetramethyl-6-(4″-methyl-[1,1′:3′,1″-terphenyl]-4-yl) heptan-1-aminium) in about 1:1 v/v mixture of cyclopentanone and 1-propanol solvent matrix was used to produce AEM via roll-to-roll technique using the Mini-Labo Deluxe with two, 1-meter-long drying ovens equipped with corona treater. In certain embodiments, the ink formulation is visibly uniform. The ink formulation preparation process and substrate preparation process described in the above examples were used. To coat, a flow rate of 11.77 mL/min, a line speed of 1.0 m/min, a die gap set at 92 μm, a first oven temperature is 50° C., and a second oven temperature of 140° C. were used. The resulting membrane had the slight appearance of pinholes and possible de-wetting. This appearance could be a result of the possible presence of polymer agglomerates in the ink formulation.

In a sixth example, an ink formulation of 13.5% w/v concentration of poly(7,7,7-trifluoro-N,N,N,6-tetramethyl-6-(4″-methyl-[1,1′:3′,1″-terphenyl]-4-yl) heptan-1-aminium) for the polymer in about 1:1 v/v mixture of dimethyl sulfoxide and 1-propanol solvent matrix was used to produce an AEM using a Mini-Labo Deluxe roll coater having two, 1-meter-long drying ovens equipped with a corona treater. The ink formulation was degassed by exposing the formulation to a vacuum environment and filtered using a 25 μm pore size bag filter. The ink formulation was coated on polyethylene terephthalate (PET) substrate pre-processed with a corona treatment. A roller line speed of 0.50 m/min, first and second oven temperatures of 80° C., and air pressure at 0.015 MPa were used. The resulting membrane had a mean thickness of 62 μm. The membrane had air bubbles and the coating was slightly wet.

In a seventh example, an ink formulation of 13.5% w/v concentration of poly(7,7,7-trifluoro-N,N,N,6-tetramethyl-6-(4″-methyl-[1,1′:3′,1″-terphenyl]-4-yl) heptan-1-aminium) for the polymer in about 1:1 v/v mixture of dimethyl sulfoxide and 1-propanol solvent matrix was used to produce an AEM. The ink formulation preparation and PET substrate preparation as described in the sixth example was used. A roller line speed of 0.50 m/min, first and second oven temperature of 100° C., and air pressure at 0.015 MPa were used. The resulting membrane had a mean thickness of 41 μm and a bumpy texture. The coating was slightly wet.

In an eighth example, an ink formulation of 13.5% w/v concentration of poly(7,7,7-trifluoro-N,N,N,6-tetramethyl-6-(4″-methyl-[1,1′:3′, 1″-terphenyl]-4-yl) heptan-1-aminium) for the polymer in about 1:1 v/v mixture of dimethyl sulfoxide and 1-propanol solvent matrix was used to produce an AEM. The ink formulation preparation and PET substrate preparation as described in the sixth example was used. A roller line speed of 0.50 m/min, first and second oven temperatures of 120° C., and air pressure at 0.015 MPa were used. The resulting membrane had a mean thickness of about 14 μm to 15 μm. The membrane had fewer air bubbles and was dry.

In a ninth example, an ink formulation of 13.5% w/v concentration of poly(7,7,7-trifluoro-N,N,N,6-tetramethyl-6-(4″-methyl-[1,1′:3′,1″-terphenyl]-4-yl) heptan-1-aminium) for the polymer in about 1:1 v/v mixture of dimethyl sulfoxide and 1-propanol solvent matrix was used to produce an AEM. The ink formulation preparation and PET substrate preparation as described in the sixth example was used. A roller line speed of 0.50 m/min, first and second oven temperatures of 120° C., and air pressure at 0.025 MPa were used. The resulting membrane had a mean thickness of about 27 μm. The membrane had larger air bubbles and was slightly wet.

In tenth example, an ink formulation of 13.5% w/v concentration of poly(7,7,7-trifluoro-N,N,N,6-tetramethyl-6-(4″-methyl-[1,1′:3′,1″-terphenyl]-4-yl) heptan-1-aminium) for the polymer in about 1:1 v/v mixture of dimethyl sulfoxide and 1-propanol solvent matrix was used to produce an AEM. The ink formulation preparation and PET substrate preparation as described in the sixth example were used. A roller line speed roller line speed of 0.50 m/min, the first and second ovens having temperatures at 140° C., and air pressure at 0.020 MPa were. The resultant membrane had a mean thickness of about 19 μm. The membrane had an increased amount of larger air bubbles and was wet.

In an eleventh example, an ink formulation of 13.5% w/v concentration of poly(7,7,7-trifluoro-N,N,N,6-tetramethyl-6-(4″-methyl-[1,1′:3′, 1″-terphenyl]-4-yl) heptan-1-aminium) for the polymer in about 1:1 v/v mixture of dimethyl sulfoxide and 1-propanol solvent matrix was used to produce AEMs. The ink formulation preparation and PET substrate preparation as described in the sixth example were used. First and second oven temperatures were 140° C. Different roller line speeds and air pressures were used, including a roller line speed is 0.10 m/min and air pressure of 0.010 MPa, 0.10 m/min and 0.020 MPa, 0.20 m/min and 0.020 MPa, and 0.30 m/min and 0.015 MPa. The resulting membranes had good film qualities, but with a notably slow production speed.

In a twelfth example, an ink formulation of 13.5% w/v concentration of poly(7,7,7-trifluoro-N,N,N,6-tetramethyl-6-(4″-methyl-[1,1′:3′,1″-terphenyl]-4-yl) heptan-1-aminium) for the polymer in about 1:1 v/v mixture of dimethyl sulfoxide and 1-propanol solvent matrix was used to produce an AEM. The ink formulation preparation and PET substrate preparation as described in the sixth example were used. A roller line speed of 0.40 m/min, first and second oven temperatures of 140° C., and air pressure at 0.015 MPa were used. The resulting membrane had a mean thickness of about 24 μm and was wet.

In a thirteenth example, an ink formulation of 13.5% w/v concentration of poly(7,7,7-trifluoro-N,N,N,6-tetramethyl-6-(4″-methyl-[1,1′:3′,1″-terphenyl]-4-yl) heptan-1-aminium) for the polymer in about 1:1 v/v mixture of dimethyl sulfoxide and 1-propanol solvent matrix was used to produce an AEM. The ink formulation preparation and PET substrate preparation as described in the sixth example were used. A roller line speed of 0.50 m/min, first and second oven temperatures of 150° C., and air pressure at 0.020 MPa were used. The corona treater remained on.

In a fourteenth example, an ink formulation of 13.5% w/v concentration of poly(7,7,7-trifluoro-N,N,N,6-tetramethyl-6-(4″-methyl-[1,1′:3′,1″-terphenyl]-4-yl) heptan-1-aminium) for the polymer in about 1:1 v/v mixture of dimethyl sulfoxide and the 1-propanol solvent matrix was used to produce an AEM. The ink formulation preparation and PET substrate preparation as described in the sixth example were used. A roller line speed roller line speed of 0.75 m/min, first and second oven temperatures at 150° C., and air pressure at 0.030 MPa were used. The resulting membrane had a mean thickness of about 24 μm.

### Layer Porosity

In some embodiments, one or more of the layers of the MEA include pores that allow gas and liquid transport. These pores are distinct from ion-conduction channels that allow ion conduction. In many polymer electrolytes (e.g. PFSA), ion conduction occurs through pores lined with stationary charges. The mobile cations hop between the oppositely charged stationary groups that line the ion conduction channel. Such channels may have variable width; for PFSA materials, the ion conduction channel diameter ranges from narrow areas of approximately 10 Å diameter to wider areas of approximately 40 Å diameter. In anion conducting polymer materials, the channel diameters may be larger, up to about a minimum width of 60 Å in the narrow areas of the channel.

For efficient ion conduction, the polymer-electrolyte is hydrated, so the ion conduction channels also contain water. It is common for some water molecules to move along with the mobile ions in a process termed electro-osmotic drag; typically 1-5 water molecules per mobile ion are moved via electro-osmotic drag. The ion-conducting channel structure and degree of electro-osmotic drag can vary with different polymer-electrolytes or ion-conducting materials. While these ion conducting channels allow ions to move along with some water molecules, they do not allow uncharged molecules to move through them efficiently. Nor do they allow bulk water that is not associated with ions to move through them. A solid (i.e., non-porous) membrane of a polymer electrolyte blocks the bulk of CO₂ and products of CO₂ electrolysis from passing through it. The typical permeability of CO₂, water, and H₂ through a wet Nafion 117 PFSA membrane at 30° C. are approximately 8.70×10⁶ mol cm cm-2 s-1·Pa-1, 4.2 (mol/cm-s-bar)×109, and 3.6 (mol/cm-s-bar)×10¹¹. Permeability depends on temperature, hydration, and nature of the polymer-electrolyte material. In ion conduction channels that have variable diameters, uncharged molecules and bulk movement of liquid/gas may be blocked at least at the narrow parts of the channel.

Pores of larger diameter that the ion conduction channels described above allow the passage of bulk liquid and gas, not just ions. The polymer electrolyte membrane layer of the MEA typically does not contain this type of pore because the membrane needs to separate reactants and products at the cathode from reactants and products at the anode. However, other layers of the MEA may have this type of pore, for example, the cathode catalyst layer may be porous to allow for reactant COₓ to reach the catalyst and for products of COₓ reduction to move out of the catalyst layer, through the gas distribution layer, and out the flow field of the electrolyzer. As used herein, the term pore refers to pores other than the ion conduction channels in an ionomer. In some embodiments, the pores of anion conducting polymer layer in an MEA have a minimum cross-sectional dimension of at least 60 Å. In some embodiments, the pores of cation conducting polymer layer in an MEA have a minimum cross-sectional dimension of at least 20 Å. This is to distinguish pores that allow gas/liquid transport from the ion conduction channels described above.

It can be useful if some or all of the following layers are porous: the cathode, the cathode buffer layer, the anode and the anode buffer layer. In some arrangements, porosity is achieved by combining inert filler particles with the polymers in these layers. Materials that are suitable as inert filler particles include, but are not limited to, TiO₂, silica, PTFE, zirconia, and alumina. In various arrangements, the size of the inert filler particles is between 5 nm and 500.mu·m, between 10 nm and 100.mu·m, or any suitable size range.

The volume of a void may be determined by the laser power (e.g., higher laser power corresponds to a greater void volume) but can additionally or alternatively be determined by the focal size of the beam, or any other suitable laser parameter. Another example is mechanically puncturing a layer to form channels through the layer. The porosity can have any suitable distribution in the layer (e.g., uniform, an increasing porosity gradient through the layer, a random porosity gradient, a decreasing porosity gradient through the layer, a periodic porosity, etc.).

The porosities (e.g., of the cathode buffer layer, of the anode buffer layer, of the membrane layer, of the cathode layer, of the anode layer, of other suitable layers, etc.) of the examples described above and other examples and variations preferably have a uniform distribution, but can additionally or alternatively have any suitable distribution (e.g., a randomized distribution, an increasing gradient of pore size through or across the layer, a decreasing gradient of pore size through or across the layer, etc.). The porosity can be formed by any suitable mechanism, such as inert filler particles (e.g., diamond particles, boron-doped diamond particles, polyvinylidene difluoride/PVDF particles, polytetrafluoroethylene/PTFE particles, etc.) and any other suitable mechanism for forming substantially non-reactive regions within a polymer layer. The inert filler particles can have any suitable size, such as a minimum of about 10 nanometers and a maximum of about 200 nanometers, and/or any other suitable dimension or distribution of dimensions. Other suitable mechanisms for forming porosity may be biaxial or uniaxial stretching.

In some embodiments, the cathode buffer layer is porous but at least one layer between the cathode layer and the anode layer is nonporous. This can prevent the passage of gases and/or bulk liquid between the cathode and anode layers while still preventing delamination. For example, the nonporous layer can prevent the direct passage of water from the anode to the cathode.

Porosity of the cathode buffer layer or any layer in the MEA may be measured as described above with respect to the catalyst layer, including using mass loadings and thicknesses of the components, by methods such as mercury porosimetry, x-ray diffraction (SAXS or WAXS), and image processing on TEM images to calculate filled space vs. empty space. Porosity is measured when the MEA is completely dry as the materials swell to varying degrees when exposed to water during operation. Porosity can be determined using the known density of the material, the actual weight of the layer per given area, and the estimated volume of the layer based on the area and thickness. The equation is as follows:

$$\\ Porosity = 100 \% - \frac{\frac{layer loading ( \frac{mg}{{cm}^{2}} )}{density of material ( \frac{mg}{{cm}^{3}} )}}{layer thickness ( cm )} \times 100 \%$$

As indicated above, the density of the material is known, and the layer loading and thickness are measured. For example, in a polymer electrolyte layer with a measured loading of 1.69 mg/cm² made of 42 wt % anion-exchange polymer electrolyte with a density of 1196 mg/cm³ and 58 wt % PTFE with a density of 2200 mg/cm³ and a total layer thickness of 11.44 microns, the porosity is:

$$\\ Porosity = 100 \% - \frac{\frac{1.69 ( \frac{mg}{{cm}^{2}} ) \times 0.42}{1196 ( \frac{mg}{{cm}^{3}} )} + \frac{1.69 ( \frac{mg}{{cm}^{2}} ) \times 0.58}{2200 ( \frac{mg}{{cm}^{3}} )}}{0.001144 ( cm )} \times 100 \% = 9.1 \%$$

As indicated above, the polymer electrolyte layers may have ion conduction channels that do not easily permit the gas/liquid transport. In the calculation above, these ion conduction channels are considered non-porous; that is, the density of the non-porous material above (42 wt % anion-exchange polymer electrolyte) includes the ion conduction channels and is defined by the calculation to be non-porous.

In another example, an ion conductive layer without filler is porous. Porosity may be introduced by appropriate deposition conditions, for example. The measured loading of the porous polymer electrolyte layer is 2.1 g/cm² and the thickness is 19 micrometers. The known density of the polymer electrolyte with ion-conducting channels but without pores is 1196 g/cm³. The porosity is then calculated as:

$$\\ Porosity = 100 \% - \frac{\frac{2.1 ( \frac{mg}{{cm}^{2}} )}{1196 ( \frac{mg}{{cm}^{3}} )}}{0.0019 ( cm )} \times 100 \% = 3.2 \%$$

### AEM/MEA Build

Provided herein are methods for fabricating MEAs. Once the AEMs are formed by the roll-to-roll methods describe above, they may be further incorporated into MEAs. In some embodiments, the AEM is first released from the substrate prior to integration with other MEA layers. The substrates may be removed by using a number of methods.

One such method involves soaking the AEM and attached substrate then using a blade to gently etch the corner and physically peel the substrate from the membrane, thereby leaving the free-standing membrane. This strategy, however, may lead to a wrinkling of the membrane once dried and may lead to a variance in electrolyzer performance.

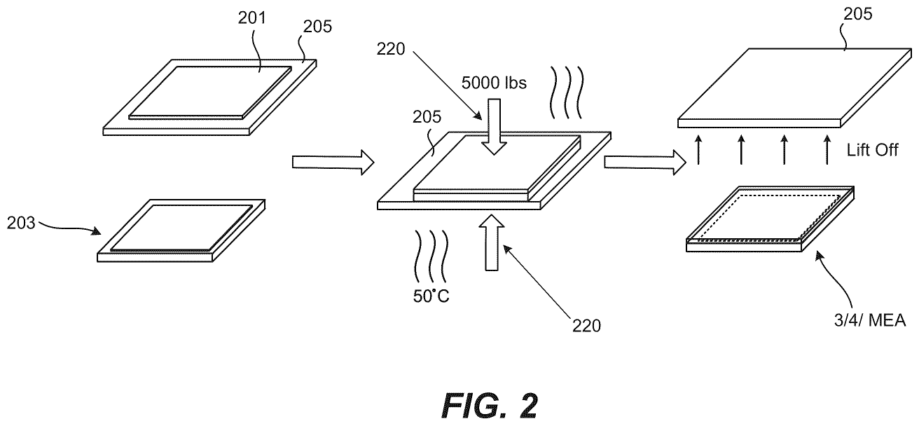

In some embodiments, the AEM is released during integration with other layers of the MEA. One such method involves using a hot press to transfer the AEM to an anode half MEA from the substrate. The anode half MEA is an anode catalyst layer deposited onto a proton-exchange membrane. The anode half MEA may be a commercially available anode half MEA. An example is shown in FIG. 2. The example of FIG. 2, a hot press 220 having a pressure of about 5000 lbs and temperature at about 50° C. is used to adhere the AEM 201 to an anode half MEA 203. Once the hot press 220 is removed, the substrate 205 is lifted off. The hot press method in MEA formation may eliminate the variability in MEAs when formed using a released AEM layer.

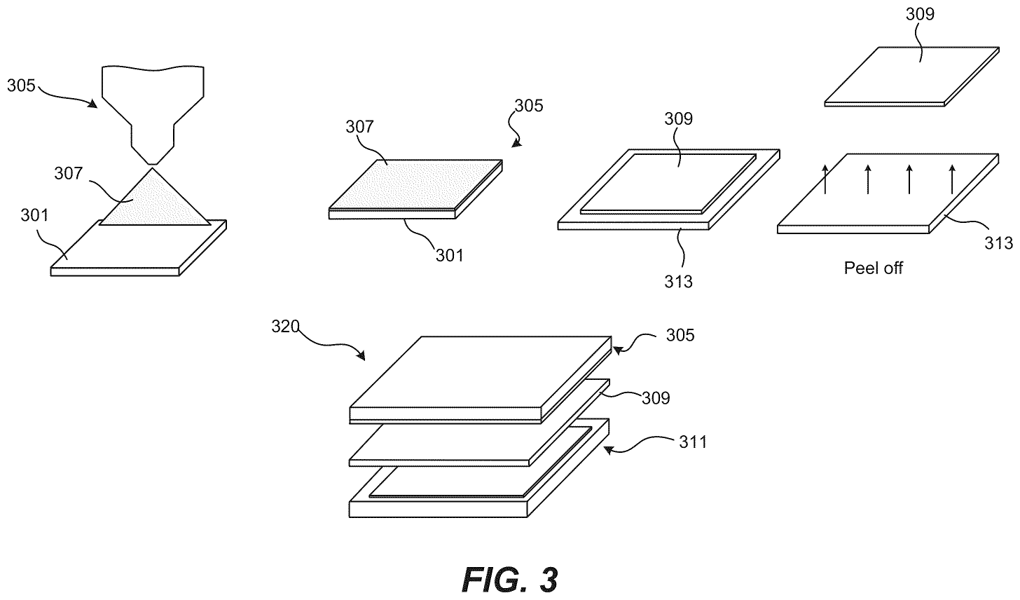

MEAs 320 incorporating roll-to-roll AEMs may be assembled by various methods. For example, a dry build method, as shown in FIG. 3, may be used. In the example of FIG. 3, a gas diffusion electrode 305 is formed separately by spray deposition of the catalyst layer 305 on a gas diffusion layer 301. In the example of FIG. 3, the catalyst 307 is gold, though any suitable supported or unsupported catalyst (e.g., copper, silver, platinum, etc.) may be used. Subsequently, the gas diffusion electrode 305 may be combined with a free-standing AEM 309 and anode half MEA 311. In some embodiments, the free-standing AEM 309 is produced by peeling off the AEM 309 from a PET 313 or other carrier substrate used in the roll-to-roll processing.

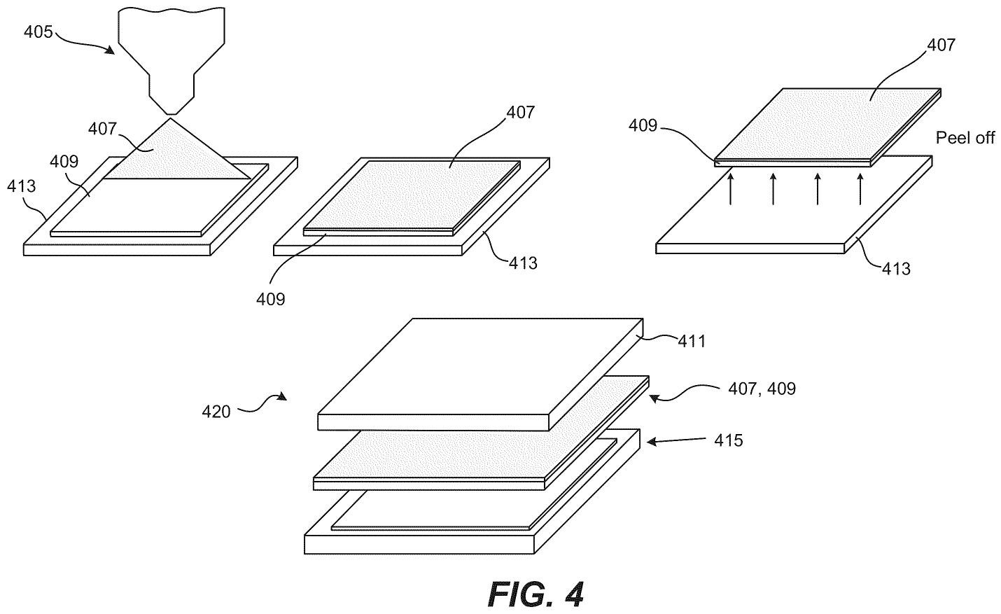

Alternatively, the MEA assembly 420 may involve spray deposition 405 of the catalyst layer 407 on the roll-to-roll AEM 409 membrane still adhered to the substrate 413, as shown in FIG. 4. Subsequently, the substrate 413 is removed from the catalyst layer 407 on the AEMs 409. In some embodiments, the free-standing AEM 409-and-catalyst layer 407 is provided by peeling off the AEMs 409-and-catalyst layer 407 from the substrate413. The free-standing AEM409-and-catalyst layer 407 is then sandwiched between the gas diffusion layer 411 and anode half MEA 415.

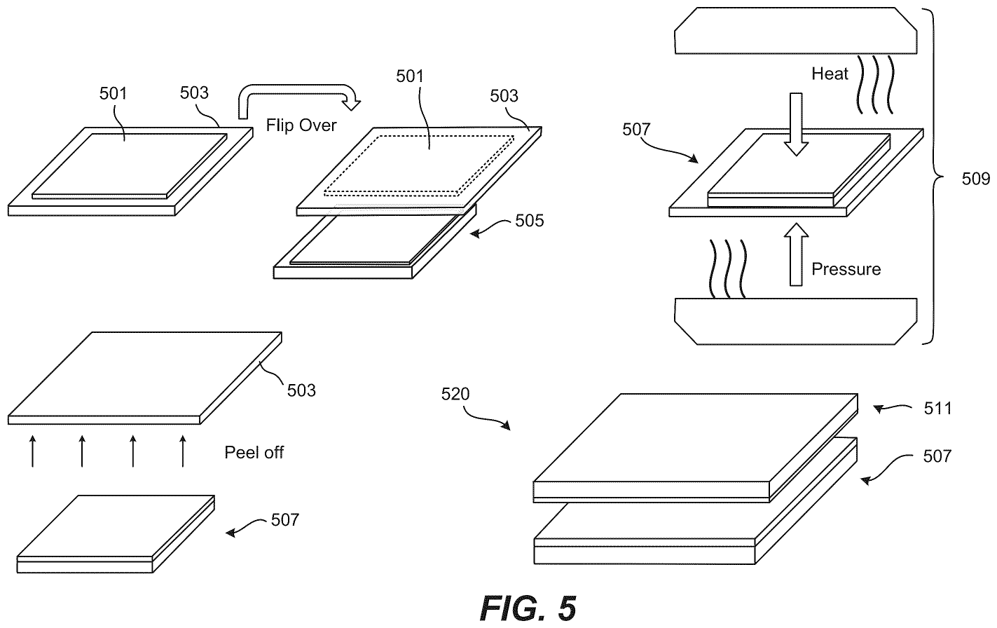

In other embodiments, the MEAs 520 may be assembled via direct transfer of the AEM 501 and substrate 503 to the anode half MEA 505, as shown in FIG. 5. This method first adheres to roll-to-roll produced AEM 501 (still adhered to the substrate503) to the anode half MEA 505, thereby forming a ¾ MEA 507. The assembly is then exposed to the hot press 509. Following the hot press 509, the substrate 503 is removed from the ¾ MEA 507 and is combined with a gas diffusion electrode 511.

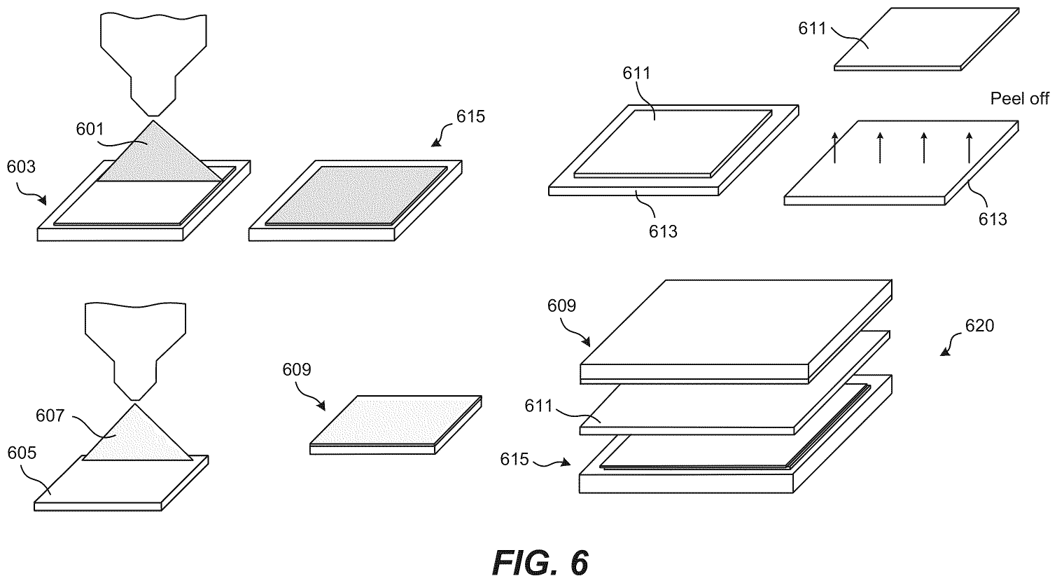

In another embodiment, the MEAs may include a carbon/Nafion interfacial layer, as shown in FIG. 6. Carbon/Nafion interfacial (CNI) layers are described in U.S. Non-Provisional patent application Ser. No. 18/327,835, filed Jun. 1, 2023, and incorporated by reference herein.

In certain embodiments, carbon/Nafion ink 601 is spray deposited onto the anode half MEA 603. A gas diffusion electrode 609 may be combined with free-standing AEM 611 and the carbon/Nafion coated anode half MEA 615. In some embodiments, the free-standing AEM 611 is produced by removing polyethylene terephthalate (PET) substrate 613 by peeling off AEMs 611 from the PET substrate 613.

In other embodiments, the carbon/Nafion ink is spray deposited onto the anode half MEA and the catalyst layer is separately spray deposited onto the roll-to-roll AEM membrane still adhered to the substrate. Subsequently, the substrate is removed from the catalyst layer on the AEMs. In some embodiments, the free-standing AEM-and-catalyst layer is provided by removing polyethylene terephthalate (PET) by peeling off the AEMs-and-catalyst layer from the substrate. The free-standing AEM-and-catalyst layer is then sandwiched between the gas diffusion layer and carbon/Nafion coated anode half MEA to form the MEA.

In another embodiment, the MEAs may be assembled via direct transfer of AEM and substrate to carbon/Nafion coated anode half MEA and a hot press. This method first adheres to roll-to-roll produced AEM still adhered to the substrate with carbon/Nafion coated anode half MEA, thereby forming a ¾ MEA. The assembly is then exposed to the hot press, wherein the ¾ MEA is exposed to heat and pressure. Following the hot press, the substrate is removed from the ¾ MEA and is combined with a gas diffusion electrode wherein the catalyst layer is spray deposited onto the gas diffusion layer.

What is claimed is:

1. An ink formulation for producing an anion-exchange membrane for a carbon oxide electrolyzer by a roll-to-roll process, the formulation comprising:
one or more poly(m-terphenyl) ionic polymers;
a solvent mixture; and
an optional additive,
wherein the poly(m-terphenyl) concentration is at least 10% w/v of the formulation.

2. The ink formulation of claim 1, wherein the ink formulation has a viscosity of about 150 cP to about 250 cP.

3. The ink formulation of claim 1, wherein the solvent mixture comprises one or more polar aprotic solvents and one or more linear alcohols.

4. The ink formulation of claim 1, wherein the solvent mixture is a 1:1 v/v mixture of cyclopentanone and n-propyl alcohol.

5. The ink formulation of claim 1, wherein the optional additive is a polyalcohol.

6. The ink formulation of claim 5, wherein the polyalcohol comprises a poly(ethylene glycol) and a poly(vinyl alcohol).

7. The ink formulation of claim 1, further comprises a binder polymer.

8. The ink formulation of claim 7, wherein the binder polymer is a sulfonated tetrafluoroethylene-based fluoropolymer-copolymer.

9. The ink formulation of claim 1 further comprises inert particles.

10. The ink formulation of claim 9, wherein the inert particles comprise one or more of polytetrafluoroethylene, clay, fibers, glass, titanium dioxide, silica, zirconia, and alumina.

11. The ink formulation of claim 1, wherein the ink formulation is filtered to remove large particulates.

12. The ink formulation of claim 1, wherein the solvent mixture is a pure solvent.

13. The ink formulation of claim 1, wherein the solvent mixture comprises one or more of dimethyl sulfoxide, ethanol, ethyl acetate, n-propyl alcohol, allyl alcohol, toluene, cyclopentanone, cyclohexanone, dimethylformamide, acetonitrile, methanol, 1-propanol, 1-butanol, and acetone.

14. The ink formulation of claim 1, wherein the poly(m-terphenyl) ionic polymer further comprises a counter ion.

15. The ink formulation of claim 14, wherein the counter ion comprises one or more of bicarbonate, halides, oxyanions, fluorophosphate anions, triflimidates, and metal halides.

16. The ink formulation of claim 1, wherein the polymer is a cross-linked poly(m-terphenyl) polymer.

17. A method of roll-to-roll deposition of an anion-exchange membrane for a carbon oxide electrolyzer comprising:
providing a substrate;
providing a roll-to-roll coater having an adjustable slot die and one or more drying ovens;
delivering the ink formulation to the roll-to-roll coater; and
coating the ink formulation to the substrate to form the anion-exchange membrane,
wherein the roll-to-roll coater is configured to control an ink flow rate, a roller line speed, and the drying oven temperature.

18. The method of claim 17, wherein the ink formulation is free of air bubbles.

19. The method of claim 17, wherein the anion-exchange membrane has a thickness greater than 10 μm.

20. The method of claim 17, wherein the anion-exchange membrane has a thickness less than 25 μm.
